(19) United States
(12) Patent Application Publication
(10) Pub. No.: US 2026/0077222 A1
(43) Pub. Date: Mar. 19, 2026

(54) SAFETY SYSTEM FOR FIRE EXTINGUISHERS

(71) Applicant: SE-KURE CONTROLS, INC., Franklin Park, IL (US)

(72) Inventor: Laura A. Greenwell, Bristol, WI (US)

(21) Appl. No.: 18/887,617

(22) Filed: Sep. 17, 2024

(51) Int. Cl. A62C 13/78

(52) U.S. Cl. CPC A62C 13/78

(57) ABSTRACT

The combination of: a) a portable fire extinguisher; b) a support for the fire extinguisher; and c) a safety system. The safety system has a controller, a detectable signal generator, and a monitoring assembly having an armed state and a triggered state. The monitoring system consists of at least one of: i) a sensor; ii) at least one tether; and iii) a location sensing assembly. The detectable signal generator generates a detectable signal as an incident of the monitoring assembly being changed from the armed state into the triggered state.

### BACKGROUND OF THE INVENTION

### FIELD OF THE INVENTION

This invention relates to portable fire extinguishers and, more particularly, to a safety system that is usable to monitor tampering with, and theft of, fire extinguishers.1

### BACKGROUND ART

Portable fire extinguishers abound worldwide and are strategically staged to be readily accessible in the event of a fire.

One category of fire extinguishers is designed to be lifted and maneuvered comfortably by an individual with average strength. A cylindrical tank contains an extinguishing agent selected, depending upon the anticipated nature of a fire to be controlled. Common to most of the fire extinguishers of this type is that there is a cantilevered handle attached to the tank which can be engaged by a user to elevate and control positioning of the fire extinguisher. An operating lever is situated near the handle so that a user can grasp, in one hand, the lever and handle and with a squeezing action pivot the lever to thereby actuate a valve that allows release of the extinguishing agent.

Typically, a locking pin with an associated ring will be directed through registrable openings in the handle and lever. The locking pin is press fit into a locking position wherein it blocks pivoting of the operating lever. When operation of the fire extinguisher is required, the ring is grasped and pulled to draw the pin out, which allows the operating lever to thereafter be pivoted to discharge extinguishing agent.

Typically, a beaded locking strap, that can be readily torn, is directed through the ring and formed into a loop around the handle in a manner that the pin is blocked in place by a part of the strap. The fire extinguisher is actuated by pulling the ring, with enough force to break the strap, fully separating the pin, and thereafter pivoting the operating lever.

For fire extinguishers to be effective, they must be readily visible where they are staged, readily accessible, and readily maneuverable. It is common to suspend the fire extinguisher from a wall mount, or the like. However, it is important that the fire extinguisher be easily disengaged from its mount and thereafter controllably maneuvered by a person with limited strength.

The ease of accessibility and operation of fire extinguishers introduces other challenges for those who maintain the fire extinguishers. Fire extinguishers that are easily engageable and repositionable are commonly the targets of thieves and vandals, particularly in public settings.

To provide some level of monitoring and control, it is known to put fire extinguishers in cases with locked doors, each having a glass window through which the stored fire extinguisher can be seen, and that can be broken with a tool that is typically staged in the vicinity of the case.

While a broken window gives a visual indication that the fire extinguisher has been accessed, it undesirably inhibits to some extent ready access to the fire extinguisher. Further, the requirement of such a structure is an added cost to keeping fire extinguishers on hand.

Still further, these cases are not designed to prevent removal, or theft, of the fire extinguishers.

Another challenge with fire extinguishers is that they must be constantly monitored to make certain that they are fully functioning and have not been tampered with. The above-described pin, held in placer by the breakable strap, affords a limited level of monitoring. As long as the pin is held in place by the strap, it may generally be assumed that no extinguishing agent in the tank has been discharged.

However, while persons in charge of making functioning fire extinguishers available may be diligent in performing their duties, there is currently no practical way to monitor and make certain that someone has not removed a fully functioning fire extinguisher and replaced it with one that is totally inoperable or has a limited quantity of extinguishing agent remaining.

Since the absence of a strap—resulting from removal or failure to initially use a strap—may not immediately raise a concern to those who casually inspect fire extinguishers on a regular basis, a situation where someone has: a) moved the fire extinguisher away from its regular staging location; b) exhausted some or all of the extinguishing agent; and c) thereafter returned the fire extinguisher to its original location, may not be reliably detected.

It remains important in many different environments to have safeguards in place to assure that fully operational fire extinguishers are always on hand, staged to be visible, and conveniently engageable for operation.

1

### SUMMARY OF THE INVENTION

In one form, the invention is directed to the combination of: a) a portable fire extinguisher; b) a support for the portable fire extinguisher; and c) a safety system. The portable fire extinguisher has a cylinder containing an extinguishing agent and an actuating mechanism that is operable to controllably release the extinguishing agent from the cylinder. The safety system includes: a controller; a detectable signal generator; and a monitoring assembly having an armed state and a triggered state. The monitoring assembly includes at least one of: i) a sensor; ii) at least one tether; and iii) a location sensing assembly. With the monitoring assembly incorporating the sensor, the monitoring assembly is in the armed state with the sensor operatively attached to the fire extinguisher and in the triggered state with the sensor separated from the fire extinguisher. With the monitoring assembly incorporating the at least one tether, the monitoring assembly is in the armed state with the at least one tether connected between the fire extinguisher and an anchoring location and in the triggered state with the at least one tether at least one of: A) disconnected from the anchoring location; and B) severed. With the monitoring assembly incorporating the location sensing assembly, the monitoring assembly is in the armed state with the fire extinguisher within a predetermined range from a monitoring location and in the triggered state with the fire extinguisher moved to outside of the predetermined range from the monitoring location. The detectable signal generator generates a detectable signal as an incident of the monitoring assembly being changed from the armed state into the triggered state.

In one form of the monitoring assembly, the sensor has a depressible button that is spring biased outwardly from a housing with the monitoring assembly in the triggered state and pressed inwardly against a bias force with the sensor operatively attached to the fire extinguisher with the monitoring assembly in the armed state.

In one form, the housing is adhesively bonded to the fire extinguisher with the sensor operatively attached to the fire extinguisher.

In one form, the fire extinguisher has at least one arm projecting away from the cylinder. The housing is maintained against the at least one arm with the sensor operatively attached to the fire extinguisher.

In one form, the safety system further includes a flexible strap that captures the housing against the at least one arm with the sensor operatively attached to the fire extinguisher.

In one form, the at least one arm includes a first arm that is part of the actuating mechanism and is pivotably mounted for movement relative to the cylinder around an axis between a stored position and an actuated position. Changing of the first arm from the stored position into the actuated position causes extinguishing agent in the cylinder to be discharged. The fire extinguisher further includes a pin configured to be press fit into a locking position wherein the pin blocks movement of the first arm from the stored position into the actuated position. The flexible strap confines movement of the pin relative to the cylinder.

In one form, a ring is provided on the pin. The flexible strap extends through the ring.

In one form, the flexible strap is a frangible strap that must be torn to allow the pin to be withdrawn from the locking position to allow the first arm to be pivoted from the stored position into the actuated position.

In one form, the at least one arm includes a second arm. The flexible strap extends around the first and second arms and through the ring.

In one form, the flexible strap extends through the housing.

In one form, the flexible strap is a restrictable beaded strap.

In one form, the monitoring assembly incorporates the sensor and the one tether. The one tether defines a conductive path between the sensor and the controller.

In one form, the safety system has a housing within which at least a part of the controller is located. The housing is fixed to an anchoring surface.

In one form, the one tether has a connector that is releasably press fit to a connector on the housing.

In one form, the connectors establish an electrical path between the one tether and the controller.

In one form, the controller is battery operated.

In one form, the housing has a cover that is movable between an open position and a closed position. The repositionable cover in the open position permits access to the controller and in the closed position blocks access to the controller. The safety system further includes a lock for maintaining the repositionable cover in the closed position.

In one form, the controller is selectively changeable between: a) a setup state wherein the detectable signal will not generate a detectable signal with the monitoring assembly in the triggered state; and b) an on state wherein the detectable signal generator generates the detectable signal with the monitoring assembly in the triggered state.

In one form, the support consists of one of: a) an upwardly facing support surface for the bottom of the cylinder; and b) a mount that is attached to a base, engages a part of the fire extinguisher, supports a weight of the fire extinguisher, and releasably maintains the fire extinguisher in a stored position.

In one form, the detectable signal generated is configured to generate at least one of: a) an audible signal; and b) a visible signal.

### BRIEF DESCRIPTION OF THE DRAWINGS

FIG. 1 is a schematic representation of the inventive combination of a portable fire extinguisher, a support for the portable fire extinguisher, and a safety system;

FIG. 2 is a schematic representation of additional details of a monitoring assembly making up part of the safety system, as shown schematically in FIG. 1;

FIG. 3 is an elevated view of one form of each of the fire extinguisher and safety system, as shown schematically in FIGS. 1 and 2;

FIG. 4 is an enlarged, elevation view of a cooperating pair of arms making up part of the actuating mechanism, as shown schematically in FIG. 1, with the arms in a stored relationship in solid lines and an actuated relationship in dotted lines, together with a locking pin used to maintain the arms in the stored relationship;

FIG. 5 is an enlarged, fragmentary view of parts of the arms in FIG. 4 in the stored relationship and with the pin in FIG. 4 in a locking position;

FIG. 6 is a partially schematic representation of one form of sensor, as shown schematically in FIG. 2, in relationship to a controller, as also shown schematically in FIG. 1;

FIG. 7 is a view as in FIG. 4 wherein the sensor in FIG. 6 has been operatively attached to one of the arms, and a flexible strap has been strategically formed into a loop to confine the locking pin in the locked position and maintain the arms in the stored relationship;

FIG. 8 is a bottom view of the sensor in FIGS. 6 and 7;

FIG. 9 is a schematic representation of connectors cooperating between a tether, as shown schematically in FIG. 2, and a controller, as shown schematically in FIG. 1;

FIG. 10 is a perspective view of the sensor and tether, as shown partially in FIG. 6, and showing additional details thereof;

FIG. 11 is a side elevation view of the strap in FIG. 7;

FIG. 12 is a schematic representation of the strap, as shown in one exemplary form in FIG. 11;

FIG. 13 is an exploded, perspective view of a housing containing at least part of the controller and a detectable signal generator, as depicted schematically in FIG. 1, and in an assembled state in FIG. 3;

FIG. 14 is a schematic representation of one form of the support, as shown schematically in FIG. 1; and

FIG. 15 is a schematic representation of another form of support/mount, as shown schematically in FIG. 1.

### DETAILED DESCRIPTION OF THE PREFERRED EMBODIMENT

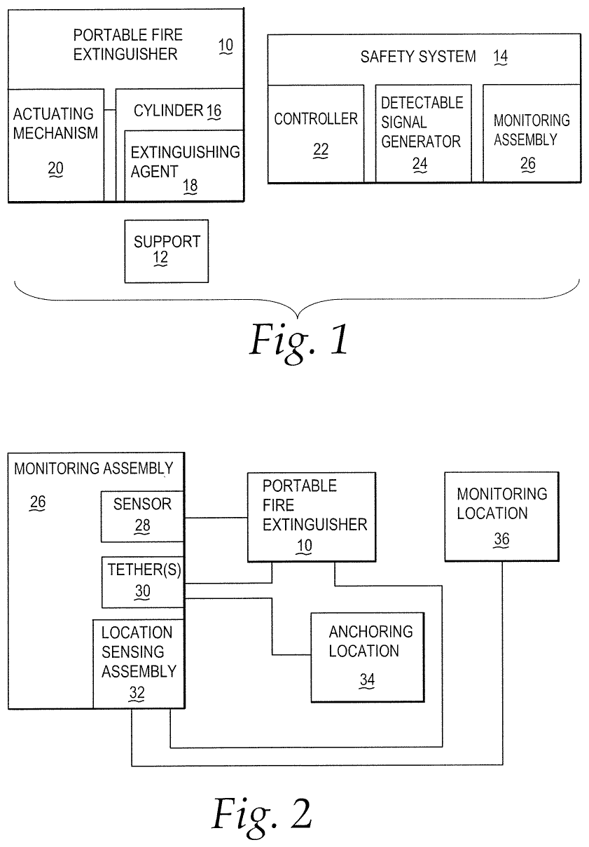

As shown schematically in FIG. 1, the present invention is directed to the combination of a portable fire extinguisher 10, a support 12 for the portable fire extinguisher, and a safety system 14.

The portable fire extinguisher 10 has a tank/cylinder 16 containing an extinguishing agent 18 and an actuating mechanism 20 that is operable to controllably release the extinguishing agent 18 from the cylinder 16.

The safety system 14 has a controller 22, a detectable signal generator 24, and a monitoring assembly 26, with the monitoring assembly 26 having an armed state and a triggered state.

As shown in FIG. 2, the monitoring assembly 26 may be made up of any one, or any combination of: a) a sensor 28; b) at least one tether 30; and c) a location sensing assembly 32.

In the case of the sensor 28, the monitoring assembly 26 is in the armed state with the sensor 28 operatively attached to the fire extinguisher 10 and in the triggered state with the sensor 28 separated from the fire extinguisher 10.

In the case of the at least one tether 30, the monitoring assembly 26 is in the armed state with the at least one tether 30 connected between the fire extinguisher 10 and an anchoring location 34, and in a triggered state with the at least one tether 30 at least one of: i) disconnected from the anchoring location 34; and ii) severed.

In the case of the location sensing assembly 32, the monitoring assembly 26 is in the armed state with the fire extinguisher 10 within a predetermined range from a monitoring location 36 and in the triggered state with the fire extinguisher 10 moved to outside of the predetermined range from the monitoring location 36.

The detectable signal generator 24 is configured to generate a detectable signal as an incident of the monitoring assembly 26 being changed from the armed state into the triggered state.

The schematic depiction of the components in FIGS. 1 and 2 is intended to encompass virtually an unlimited number of variations of each of the components and their interaction.

For example, the tether 30 may be a mechanical tether and/or one that makes an electrical connection to permit operation, as described above.

Similarly, the location sensing assembly 32 may take virtually an unlimited number of different forms, including those currently existing and those that might be devised to sense when the fire extinguisher 10 has been moved to outside of a controlled range.

The detectable signal generator 24 is configured to generate a visual and/or audible signal, which in the former case might be a message to a computer, an illuminated source of light, etc.

The controller 22 may vary significantly in terms of its construction. Virtually any controller design capable of generating a detectable signal upon detecting a breach event for which the controller was designed—be it by reason of there being severance of an electrical connection, changing a wireless system signal, etc.—is contemplated. The schematic depiction of the controller is intended to cover virtually unlimited different controller designs that one skilled in the art might select or design to achieve the ends stated herein.

The specific forms of the combination, described hereinbelow, are exemplary in nature only and the details thereof should not be viewed as limiting in any sense the broader disclosure in FIGS. 1 and 2.

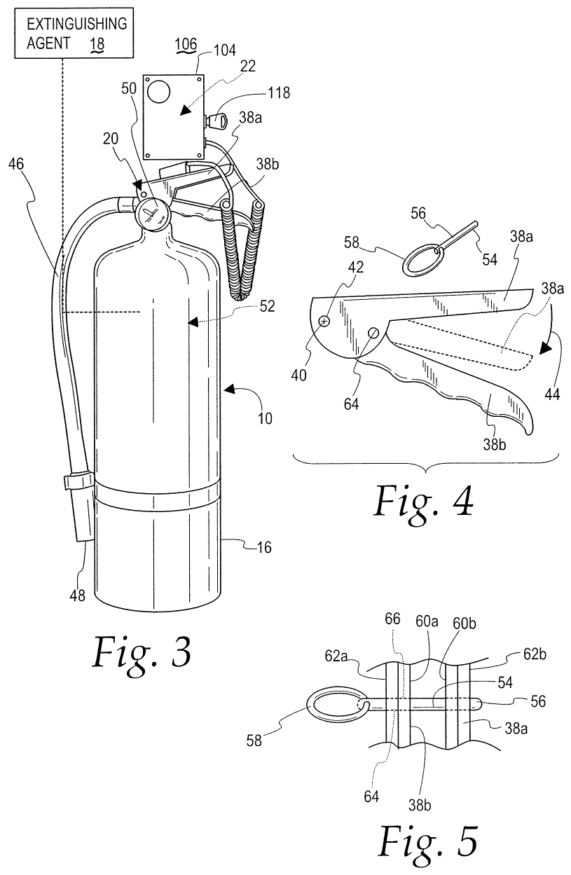

The schematic depiction of the portable fire extinguisher 10 in FIG. 1 is intended to encompass virtually any type of structure that contains an extinguishing agent 18 to smother smoke and/or put out a fire and that is releasably discharged through the operation of an actuating mechanism. As shown in FIGS. 3-15, the exemplary portable fire extinguisher 10 has the aforementioned cylinder/tank 16 atop which the actuating mechanism 20 is located.

The actuating mechanism 20 consists of two arms 38a, 38b, each projecting away from the cylinder 16. In the depicted form, the arm 38b is substantially fixed relative to the cylinder 16, with the arm 38a pivotable relative to the arm 38b around an axis 40 defined by a pivot pin 42. Pivoting of the arm 38a towards the arm 38b, as indicated by the arrow 44 in FIG. 4, causes the extinguishing agent 18 within the cylinder 10 to be discharged through a flexible hose 46 having a discharge nozzle 48.

As depicted, the arm 38a is pivotably mounted for movement relative to the cylinder 16 between a stored position, as shown in solid lines in FIG. 4, and an actuated position, as shown in dotted lines, also in FIG. 4. Pivoting of the arm 38a towards or into the actuated position causes discharge of the extinguishing agent 18.

A pressure gauge 50 has a display to indicate the pressure built up within an internal cylinder volume 52 within which the extinguishing agent 18 is stored.

A pin/locking pin 54 has an elongate body 56 with a ring 58 attached thereto either fixedly or for pivoting movement relative to the elongate body 56.

With the arm 38a in the stored position, as shown in FIG. 5, spaced wall portions 60a, 60b on the arm 38b reside between spaced wall portions 62a, 62b on the arm 38a. With the arm 38a in the stored position, an opening 64 through the wall portions 62a, 62b registers with an opening 66 through the wall portions 60a, 60b.

As shown in FIG. 5, with the arm 38a in the stored position, the locking pin body 56 can be directed through the openings 64, 66 so as to thereby prevent pivoting of the arm 38a relative to the arm 38b out of the stored position therefor and towards or into the actuated position.

It should be understood that the arm 38b might also be mounted for pivoting movement relative to the cylinder 16.

With either construction, the arms 38a, 38b are commonly configured so that a user can extend his/her hand in a gripping arrangement and squeeze the arms 38a, 38b together to change the arm 38a from the stored position into the actuated position.

When it is desired to change the arm 38a from the stored position into the actuated position therefor, the ring 58 is grasped and used to draw the pin 54 out of its locking position and to fully separate the pin 54 from the arms 38a, 38b, whereupon their relative movement is unimpeded.

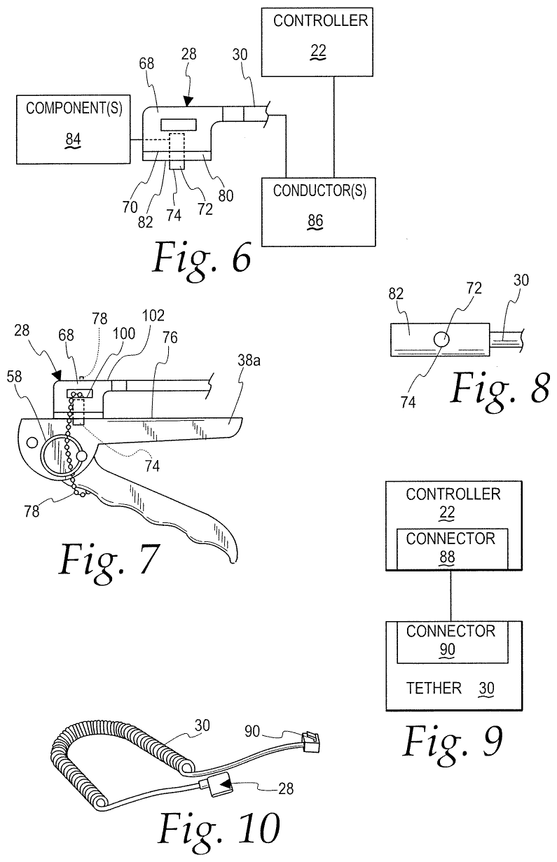

As shown in FIGS. 6, 7, and 10, an exemplary form of the sensor 28 has a housing 68 with a generally flat mounting surface 70. A depressible button 72 is spring biased outwardly to the FIG. 6 position wherein an end 74 of the button 72 projects beyond the mounting surface 70 whereupon the sensor 28 causes the monitoring assembly 26 to be placed in the triggered state.

The sensor 28 is operatively attached to the fire extinguisher, as shown in FIG. 7, by urging the mounting surface 70 on the housing 68 towards, or against, a surface 76 on the arm 38a. The housing 68 could be mounted virtually anywhere on the fire extinguisher. As this occurs, the button 72 is pressed inwardly of the housing 68 against a bias force, whereupon the sensor 28 causes the monitoring assembly 26 to be placed in the armed state therefor.

While the sensor housing 68 may be operatively attached using only a strap 78, as hereinafter described in detail, in the depicted form a double-sided adhesive pad 80 is additionally used. Further, the pad 80 may be used by itself to effect attachment of the housing 68.

With the pad 80 interposed between the surfaces 70, 76, to bond the housing 68 to the surface 76, the end 74 of the button 72 is substantially flush with the bottom surface 82 of the pad 80.

The housing 68 contains electrical components 84 which are operated by the repositioning button 72 to send an appropriate signal through one or more conductors 86, in turn connected to the controller 22.

In this embodiment, the conductor(s) 86 also define a mechanical tether 30, as shown schematically in FIG. 2.

The configuration of the components in FIG. 6 may vary considerably, with the primary goal being that with the sensor 28 operatively attached to the fire extinguisher 10, the controller 22 will cause the detectable signal generator 24 to generate a signal in the event that the sensor 28 is separated from the fire extinguisher or the tether 30 is severed.

Alternatively, as shown in FIG. 9, the controller 22 may have a mechanical and/or electrical connector 88 that cooperates with an electrical and/or mechanical connector 90 on the tether 30 such that the tether connector 90 can be disconnected from the controller connector 88 at the particular anchoring location 34.

In FIG. 10, the tether 30, which has a coiled shape, is shown connected to the housing 28 with a conventional push-in type connector 90.

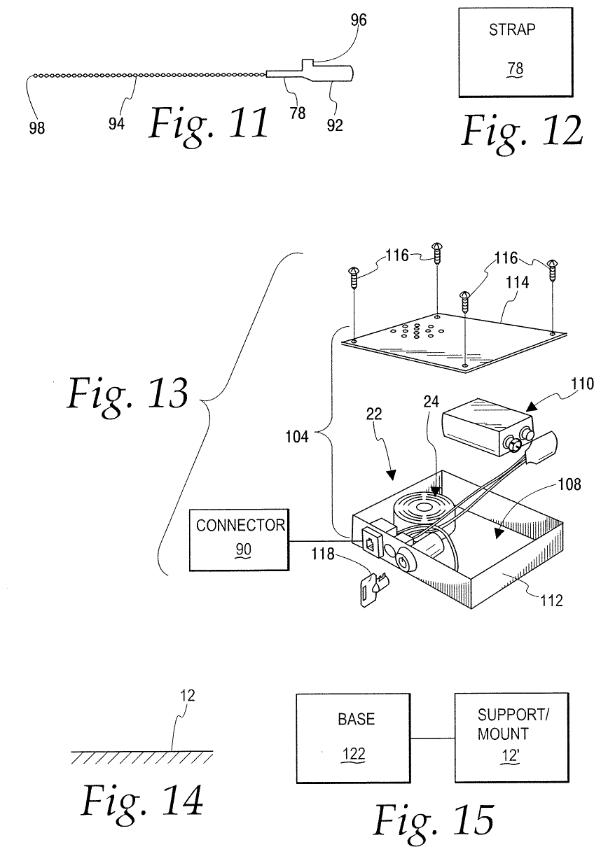

In FIGS. 7 and 11, additional details of the strap 78 are shown. The schematic depiction of the strap 78 in FIG. 12 is intended to encompass the specific form herein as well as virtually any type of flexible component that can be wrapped around in a loop shape and preferably restricted in diameter.

As shown in FIG. 11, the strap 78 has a locking component 92 integrally formed with a flexible beaded length 94. The locking component 92 has a conventional one-way receiver 96 through which the free end 98 of the beaded length 94 is directed in the appropriate direction so that it is blocked against being withdrawn. Further direction of the length 94 through the receiver 96 further reduces the effective loop diameter.

The strap 78, as seen in FIG. 7, is directed through an opening 100 in the sensor housing 68 and around the arms 38a, 38b. With the free end 98 of the strap 78 directed into the receiver 96, a diameter of the loop formed thereby can be restricted to capture the housing 68 against the arm surface 76, thereby generating a force tending to maintain the sensor 38 operatively attached to the fire extinguisher 10.

As shown in dotted lines in FIG. 7, the strap 78 may alternatively be wrapped over the top 102 of the housing 68 to maintain the sensor operatively attached to the arm 38a.

As shown in FIG. 7, the strap 78 also extends preferably through the ring 58 on the locking pin 54 to block the locking pin 54 against inadvertent withdrawal from its locking position.

With this configuration, the strap 78 is made with a sufficiently frangible construction that it can be readily torn/ruptured by pulling on the pin 54, thereby allowing the pin 54 to be withdrawn from its locking position to in turn allow the arm 38a to be pivoted from the stored position into the actuated position.

As shown in FIGS. 3 and 13, a housing 104 is fixed to an anchoring surface 106 and contains at least a part of the controller 22. As shown in FIG. 13, the housing bounds an internal volume 108 to accommodate at least part of the controller 22 and additionally receives a battery at 110 for operating the controller 22.

In this embodiment, the housing 104 has a cup-shaped portion 112 defining the volume 108 which is selectively blocked by a removable cover 114. The cover 114 is movable between an open position, as shown in FIG. 13, and a closed position, as shown in FIG. 3. In the open position, access can be gained to the controller components within the volume 108 as well as the detectable signal generator 24. The cover 114 is maintained in the closed position through fasteners 116 which function as a lock. Alternatively, a hinged cover 114 might be used with a conventional key-operated lock, or the like.

Through an externally operated key 118, the controller 22 is selectively changeable between: a) a setup state wherein the detectable signal will not generate a detectable signal with the monitoring assembly in the triggered state, and b) and on state wherein the detectable signal generator generates the detectable signal with the monitoring assembly in the triggered state.

The aforementioned support 12 may be an upwardly facing surface against which a bottom of the cylinder 16 might bear.

Alternatively, as shown in FIG. 15, the support 12′ may be in the form of a mount that is attached to a base 122, engages a part of the fire extinguisher, and supports a weight of the fire extinguisher to releasably maintain the fire extinguisher in a stored position. A drop-in arrangement is contemplated in one exemplary form.

With the inventive structure, the fire extinguisher 10 can be operated substantially in normal fashion. The pin 54 is drawn outwardly through the ring 58, thereby rupturing the strap 78. Changing of the monitoring assembly 26 into the triggered state causes the detectable signal generation to alert appropriate personnel that the fire extinguisher is being used, tampered with, or stolen.

The connector 90 can be released and/or the housing 68 can be drawn off of the arm 38a in the event that immediate use of the fire extinguisher 10 is required.

If more time is available, the controller can be changed from the on state to the setup state to avoid triggering an “alarm”.

However, significantly, the safety system will discourage tampering, misuse, and theft.

The foregoing disclosure of specific embodiments is intended to be illustrative of the broad concepts comprehended by the invention.

1. In combination:
a) a portable fire extinguisher comprising:
a cylinder containing an extinguishing agent; and
an actuating mechanism that is operable to controllably release the extinguishing agent from the cylinder;
b) a support for the portable fire extinguisher; and
c) a safety system comprising:
a controller;
a detectable signal generator; and
a monitoring assembly having an armed state and a triggered state,
the monitoring assembly comprising at least one of: i) a sensor; ii) at least one tether; and iii) a location sensing assembly,
with the monitoring assembly comprising the sensor, the monitoring assembly is in the armed state with the sensor operatively attached to the fire extinguisher and in the triggered state with the sensor separated from the fire extinguisher,
with the monitoring assembly comprising the at least one tether, the monitoring assembly is in the armed state with the at least one tether connected between the fire extinguisher and an anchoring location and in the triggered state with the at least one tether at least one of: A) disconnected from the anchoring location; and B) severed,
with the monitoring assembly comprising the location sensing assembly, the monitoring assembly is in the armed state with the fire extinguisher within a predetermined range from a monitoring location and in the triggered state with the fire extinguisher moved to outside of the predetermined range from the monitoring location,
the detectable signal generator generating a detectable signal as an incident of the monitoring assembly being changed from the armed state into the triggered state.

2. The combination according to claim 1 wherein the monitoring assembly comprises the sensor, the sensor having a depressible button that is spring biased outwardly from a housing with the monitoring assembly in the triggered state and pressed inwardly against a bias force with the sensor operatively attached to the fire extinguisher with the monitoring assembly in the armed state.1

3. The combination according to claim 2 wherein the housing is adhesively bonded to the fire extinguisher with the sensor operatively attached to the fire extinguisher.

4. The combination according to claim 2 wherein the fire extinguisher comprises at least one arm projecting away from the cylinder and the housing is maintained against the at least one arm with the sensor operatively attached to the fire extinguisher.

5. The combination according to claim 4 wherein the safety system further comprises a flexible strap that captures the housing against the at least one arm with the sensor operatively attached to the fire extinguisher.

6. The combination according to claim 5 wherein the at least one arm comprises a first arm that is part of the actuating mechanism and pivotably mounted for movement relative to the cylinder around an axis between a stored position and an actuated position, changing of the first arm from the stored position into the actuated position causing extinguishing agent in the cylinder to be discharged, the fire extinguisher further comprising a pin configured to be press fit into a locking position wherein the pin blocks movement of the first arm from the stored position into the actuated position, wherein the flexible strap confines movement of the pin relative to the cylinder.

7. The combination according to claim 6 wherein the pin comprises a ring and the flexible strap extends through the ring.

8. The combination according to claim 7 wherein the flexible strap is a frangible strap that must be torn to allow the pin to be withdrawn from the locking position to allow the first arm to be pivoted from the stored position into the actuated position.

9. The combination according to claim 7 wherein the at least one arm comprises a second arm and the flexible strap extends around the first and second arms and through the ring.

10. The combination according to claim 5 wherein the flexible strap extends through the housing.

11. The combination according to claim 5 wherein the flexible strap is a restrictable beaded strap.

12. The combination according to claim 1 wherein the monitoring assembly comprises the sensor and the one tether, the one tether defining a conductive path between the sensor and the controller.

13. The combination according to claim 12 wherein the safety system comprises a housing within which at least a part of the controller is located, and the housing is fixed to an anchoring surface.

14. The combination according to claim 13 wherein the one tether has a connector that is releasably press fit to a connector on the housing.

15. The combination according to claim 14 wherein the connectors establish an electrical path between the one tether and the controller.

16. The combination according to claim 1 wherein the controller is battery operated.

17. The combination according to claim 1 wherein the housing has a cover that is movable between an open position and a closed position, the repositionable cover in the open position permitting access to the controller and in the closed position blocking access to the controller, the safety system further comprising a lock for maintaining the repositionable cover in the closed position.

18. The combination according to claim 1 wherein the controller is selectively changeable between: a) a setup state wherein the detectable signal will not generate a detectable signal with the monitoring assembly in the triggered state; and b) an on state wherein the detectable signal generator generates the detectable signal with the monitoring assembly in the triggered state.

19. The combination according to claim 1 wherein the support comprises one of: a) an upwardly facing support surface for a bottom of the cylinder; and b) a mount that is attached to a base, engages a part of the fire extinguisher, supports a weight of the fire extinguisher, and releasably maintains the fire extinguisher in a stored position.

20. The combination according to claim 1 wherein the detectable signal generated is configured to generate at least one of: a) an audible signal; and b) a visible signal.
